(19) United States
(12) Patent Application Publication
(10) Pub. No.: US 2026/0278256 A1
(43) Pub. Date: Sep. 17, 2026

(54) SYSTEMS AND METHODS OF DATA PREPROCESSING AND EXTRACTION FROM COMPLEX DOCUMENTS

(71) Applicant: PwC Product Sales LLC, New York, NY (US)

(72) Inventors: David Robert RESSEGUIE, Knoxville, TN (US); Timothy GARVIN, Cuyahoga Falls, OH (US); Neh Vivek KOVALE, Dallas, TX (US); Zijie RONG, Houston, TX (US)

(73) Assignee: PwC Product Sales LLC, New York, NY (US)

(21) Appl. No.: 19/075,927

(22) Filed: Mar. 11, 2025

(51) Int. Cl. G06F 40/177; G06F 3/04842; G06F 16/335; G06F 40/205; G06F 40/242; G06V 30/10; G06V 30/412

(52) U.S. Cl. CPC G06F 40/177; G06F 3/04842; G06F 16/335; G06F 40/205; G06F 40/242; G06V 30/10; G06V 30/412

(57) ABSTRACT

A computer-implemented method is provided, including: receiving a document file having a document page and location data comprising a y-coordinate location of a table on the document page; parsing tabular data from the document page at the y-coordinate location; determining a table complexity level based on the parsed tabular data; modifying the parsed tabular data based on the table complexity level; parsing text data from the document from the document page, wherein the text data is located at a different y-coordinate location than the tabular data; combining the modified parsed tabular data and the parsed text data to generate a merged input data structure; providing the merged input data structure and a prompt to a large language model (LLM); and receiving a structured output from the LLM comprising a target type of information in a desired output format.

### FIELD

This disclosure relates generally to the preprocessing of data for use by an artificial intelligence (AI) model, and more specifically, to the preprocessing of structured and unstructured data for extraction from a complex document using an AI model.

### BACKGROUND

There are many use cases in which processing documents using AI models provides improvements in efficiency, accuracy, and costs. However, many documents include complex terminologies, diverse formatting styles, and varied data placements. These complex documents often include a combination of structured and unstructured data, with the structured data often lacking a standardized format.

### SUMMARY

Current methods of extracting information from these documents, such as the use of optical character recognition (OCR) engines with classical machine learning pipelines, have various shortcomings and deficiencies. For example, data from complex documents is often extracted in an inaccurate or incomplete manner, and the extracted data may not reflect the relative order of information as it appears in the original document. This can lead to the inability for documents to be accurately and automatically ingested for processing by AI models.

Accordingly, there exists a need for a method of extracting information from complex documents in a comprehensive and accurate manner that also preserves the relative order of information as it appears on each document page. The methods described herein may address this need by leveraging a sophisticated combination of data preprocessing steps to enable the complete and accurate extraction of information by an AI model, even if the AI model is presented with complex documents.

For example, a method as described herein may involve receiving a document that may include unstructured text, footnotes, simple tables, and/or complex tables. The received document may be “complex” in that it may lack a uniform or standardized format throughout. Location data associated with the location of structured data (e.g., x- and y-coordinates) on each page of the document may also be received. A prompt may also be received that includes a request for an AI model, such as a large language model (LLM), to extract a target type of information from the document (e.g., footnotes, headers, lists, etc.) along with instructions for a desired format of the structured output (e.g., a JSON output).

To preprocess the document for extraction by the LLM, a method may utilize an optical character recognition (OCR) engine such as Microsoft Azure Document Intelligence. The OCR engine may use metadata fields to distinguish between structured data and unstructured data in the document, and both types of data may be preprocessed for the LLM input using different techniques. For tabular data, a type of structured data, different preprocessing techniques may also be performed depending on whether a table is “simple” or “complex.” As used herein, simple tables may include an “M” total number of rows and an “N” total number of columns, with the total number of cells in the table being equal to M×N. Complex tables may have one or more merged or split cells, such that they do not have a regular number of rows across all columns or a regular number of columns across all rows. Thus, the total number of cells in a complex table may not equal “M×N.” In other words, a “complex” table may not have a 1-to-1 correspondence between an actual number of cells and a number of cells expected from multiplying the number of rows by the number of columns.

For “simple” tables, a method may include parsing tabular data using the OCR engine and normalizing the parsed tabular data into a format that can be understood by an LLM. Extraneous metadata fields may be removed from the parsed tabular data so that the LLM input includes only the most relevant information for the LLM to extract from. Further, simple tables may be recursively split into groups of one or more rows, in order from top to bottom, to avoid exceeding a token limit of the LLM while maintaining the integrity of the tabular data. For “complex” tables, a preprocessing method may replace the tables with a placeholder value while maintaining the relative location of the complex table as it appeared on the document page. In this manner, simple tables can be preprocessed into a more digestible and manageable input for the LLM to use during data extraction, while complex tables may be removed from the AI model input and replaced after data extraction is performed by the LLM so that the LLM is not overwhelmed by complex tabular data.

In addition to tabular data, an OCR engine may be used to perform rasterized parsing of unstructured text. One or more metadata fields may be used to assemble the unstructured text into lines as they appear on the document page, based on x- and y-coordinates of each word on the document page, the average number of words in a line, and the average space between lines on a page, for example. The parsed lines of text may be merged into a list with the simple tables and complex table placeholders to create a merged input data structure in the form of a list. The parsed text and tabular data may be presented in the same relative order in the list as they appeared on the original document page using their respective y-coordinates. By formatting the LLM input to accurately reflect the relative locations of structured and unstructured data on the document page, the LLM output may, in turn, accurately reflect the relative locations of the extracted data provided in its output.

The LLM may receive an input including the preprocessed text and tabular data for each page of the received document file converted into a string. The LLM may also be provided with the prompt specifying a target type of information to be extracted from the input, along with the instructions for the desired format of the output. For each page of the document file, the LLM may provide an output containing the extracted information from the page in the desired format. Once every page of the document has been processed, each of the outputs may be combined into a dictionary object that can be provided to a user or a downstream system. For example, a visual representation of the information contained in the dictionary object may be provided to a frontend user at a user interface, enabling the user to compare, analyze, and/or export the extracted information for various applications such as assessing tax compliance. Alternatively, the dictionary object may be provided to a downstream system, enabling the seamless exchange of extracted document information from one system to another. Furthermore, multiple dictionary objects corresponding to different documents may be stored in data repositories, creating one or more knowledge bases of extracted, usable information derived from complex documents.

In some examples, a computer-implemented method is provided, including: receiving a document file comprising a document page and location data comprising a y-coordinate location of a table on the document page; parsing tabular data from the document page at the y-coordinate location specified by the location data; determining a table complexity level based on the parsed tabular data; modifying the parsed tabular data based on the table complexity level; parsing text data from the document page, wherein the text data is located at a different y-coordinate location than the tabular data; combining the modified parsed tabular data and the parsed text data to generate a merged input data structure; providing the merged input data structure and a prompt to a large language model (LLM), the prompt specifying a target type of information to be extracted by the LLM and a desired output format; and receiving a structured output from the LLM comprising the target type of information in the desired output format, wherein a relative order of the tabular data with respect to the text data based on the y-coordinate locations in the document page is maintained in the structured output.

In some examples, the computer-implemented method includes determining that the table complexity level is a complex table; and in response to determining that the table complexity level is a complex table, modifying the parsed tabular data to replace the table with a placeholder value.

In some examples, the computer-implemented method includes determining that the table complexity level is a simple table; in response to determining that the table complexity level is a simple table: normalizing a dataframe of the parsed tabular data, recursively splitting the normalized dataframe into a plurality of frames based on a token limit of the LLM, and modifying the parsed tabular data to include the plurality of frames.

In some examples, creating the merged input data structure includes converting the modified parsed tabular data and the parsed text data into a string, and wherein the computer-implemented method further comprises selecting an LLM to receive the merged input data structure based on a size of the string.

In some examples, the computer-implemented method includes repeating the steps of the computer-implemented method, from receiving the document file comprising the document page and the location data to receiving the structured output from the LLM, for each page in the document file; constructing a dictionary object comprising each structured output received from the LLM for each page in the document file; and storing the dictionary object in a data store.

In some examples, the computer-implemented method includes displaying a visual representation of information from the dictionary object at a user interface.

In some examples, the computer-implemented method includes receiving a user selection of a visual affordance for exporting information from the dictionary object into an external file type; and in response, exporting the information from the dictionary object into the external file type.

In some examples, the computer-implemented method includes receiving a user selection of a visual affordance for filtering at least a portion of the information from the dictionary object; filtering the portion of the information from the dictionary object in response to the user selection; and displaying a visualization of the filtered portion of the information to a user at the user interface.

In some examples, the document file is uploaded by a user at a user interface.

In some examples, a system is provided, the system including one or more processors, and memory storing computer program code executable by the one or more processors to cause the system to: receive a document file comprising a document page and location data comprising a y-coordinate location of a table on the document page; parse tabular data from the document page at the y-coordinate location specified by the location data; determine a table complexity level based on the parsed tabular data; modify the parsed tabular data based on the table complexity level; parse text data from the document page, wherein the text data is located at a different y-coordinate location than the tabular data; combine the modified parsed tabular data and the parsed text data to generate a merged input data structure; provide the merged input data structure and a prompt to a large language model (LLM), the prompt specifying a target type of information to be extracted by the LLM and a desired output format; and receive a structured output from the LLM comprising the target type of information in the desired output format, wherein a relative order of the tabular data with respect to the text data based on the y-coordinate locations in the document page is maintained in the structured output.

In some examples, the system is further caused to determine that the table complexity level is a complex table; and in response to determining that the table complexity level is a complex table, modify the parsed tabular data to replace the table with a placeholder value.

In some examples, the system is further caused to determine that the table complexity level is a simple table; in response to determining that the table complexity level is a simple table: normalize a dataframe of the parsed tabular data, recursively split the normalized dataframe into a plurality of frames based on a token limit of the LLM, and modify the parsed tabular data to include the plurality of frames.

In some examples, creating the merged input data structure comprises converting the modified parsed tabular data and the parsed text data into a string, and the system is further caused to select an LLM to receive the merged input data structure based on a size of the string.

In some examples, the system is further caused to: repeat the steps of receiving the document file comprising the document page and the location data to receiving the structured output from the LLM, for each page in the document file; construct a dictionary object comprising each output received from the LLM for each page in the document file; and store the dictionary object in a data store.

In some examples, the system is further caused to display a visual representation of information from the dictionary object at a user interface.

In some examples, the system is further caused to: receive a user selection of a visual affordance for exporting information from the dictionary object into an external file type; and in response, export the information from the dictionary object into the external file type.

In some examples, the system is further caused to: receive a user selection of a visual affordance for filtering at least a portion of the information from the dictionary object; filter the portion of the information from the dictionary object in response to the user selection; and display a visualization of the filtered portion of the information to a user at the user interface.

In some examples, the document file is uploaded by a user at a user interface.

In some examples, a non-transitory computer readable storage medium storing one or more programs is provided, the one or more programs including instructions, which, when executed by a system comprising one or more processors, cause the system to: receive a document file comprising a document page and location data comprising a y-coordinate location of a table on the document page; parse tabular data from the document page at the y-coordinate location specified by the location data; determine a table complexity level based on the parsed tabular data; modify the parsed tabular data based on the table complexity level; parse text data from the document page, wherein the text data is located at a different y-coordinate location than the tabular data; combine the modified parsed tabular data and the parsed text data to generate a merged input data structure; provide the merged input data structure and a prompt to a large language model (LLM), the prompt specifying a target type of information to be extracted by the LLM and a desired output format; and receive a structured output from the LLM comprising the target type of information in the desired output format, wherein a relative order of the tabular data with respect to the text data based on the y-coordinate locations in the document page is maintained in the structured output.

In some examples, a computer-implemented method is provided, including: receiving a document file, location data comprising a table location in the document file, and one or more screenshots of one or more pages of the document file; parsing tabular data from the document file at the table location; determining a table complexity level based on the tabular data; upon determining that the table complexity level is a simple table: normalizing a dataframe of the tabular data, and recursively splitting the normalized dataframe into a plurality of frames based on a token limit of a large language model (LLM); encoding the one or more screenshots to create an encoded image input; receiving an LLM input comprising a string corresponding to each frame of the plurality of frames and the encoded image input, wherein the LLM input does not exceed the token limit; and receiving an LLM output comprising information extracted from the encoded image cross-referenced with information from the document file.

In some examples, a computer-implemented method is provided, including: receiving a document file and location data comprising a table location in the document file; parsing tabular data from the document file at the table location specified by the location data; parsing text data at a location in the document file other than the location specified by the location data; determining a table complexity level based on the tabular data; upon determining that the table complexity level is a simple table: normalizing a dataframe of the tabular data, and recursively splitting the normalized dataframe into a plurality of frames based on a token limit of a large language model (LLM); receiving a first input at the LLM comprising a string corresponding to each frame of the plurality of frames, wherein the first input does not exceed the token limit; receiving a first LLM output comprising information extracted from the string; receiving a second input at the LLM comprising the parsed text data; receiving a second LLM output comprising information extracted from the parsed text data; and combining the first LLM output and the second LLM output to create a merged output comprising information extracted from the string and information extracted from the parsed text data.

In some examples, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIGS. 1-4 illustrate exemplary methods of data preprocessing and extraction, according to some examples.

FIG. 5 illustrates a file upload page of a user interface, according to some examples.

FIG. 6 illustrates a document processing status page of a user interface, according to some examples.

FIG. 7 illustrates a document repository page of a user interface, according to some examples.

FIGS. 8A and 8B illustrate a document comparison page displayed in a user interface, according to some examples.

FIGS. 9A-11B illustrate extracted information outputs from the methods described herein, compared with traditional methods, according to some examples.

FIG. 12 illustrates an executive review page of a user interface, according to some examples.

FIGS. 13A and 13B illustrate document extraction results exported to an external format, according to some examples.

FIG. 14 illustrates a computer, according to some examples.

FIG. 15 illustrates a system, according to some examples.

### DETAILED DESCRIPTION

Provided are methods of data preprocessing and extraction that can enable comprehensive and accurate extraction of information from complex documents using an AI model, such as an LLM. For example, a method of data preprocessing and extraction may involve receiving a document file with a document page and location information that includes the coordinates of structured data. This structured data may include, for example, tables or other structured information. The structured data may be parsed by an OCR engine and preprocessed separately from unstructured data.

If the structured data includes tables, an initial determination may be made as to whether a table is “simple” or “complex.” Simple tables may include an “M” total number of rows and an “N” total number of columns, with the total number of cells in the table being equal to M×N. Complex tables may have one or more merged or split cells, such that they do not have a regular number of rows across all columns or a regular number of columns across all rows. Thus, the total number of cells in a complex table may not have a 1-to-1 correspondence with the number of rows multiplied by the number of columns.

Tables that are identified as “simple” in this step may be converted into a normalized dataframe and recursively split into rows based on a token limit of the LLM. On the other hand, tables that are identified as “complex” may be replaced with placeholders located at the same y-coordinate as the original table, so that their relative location on the document page is reflected in the output. Inaccuracies in the output caused by exceeding a token limit of the LLM or by overwhelming the LLM with the complex tables can thus be avoided. Additionally, unstructured text data may be preprocessed separately from the structured data. For example, rasterized parsing may be performed on the text, which may involve analyzing one or more metadata fields of the unstructured text to parse lines that accurately reflect the location of each of the words as indicated by the metadata. The locations (e.g., x- and/or y-coordinates) of each of the words on the page may be determined, and the preprocessed text may be recombined with the preprocessed tabular data to create a merged input data structure, such as a list. The merged input may be created based on the coordinates of the tables and/or text in the original document, thereby reflecting the original order of data as it was presented on the document page.

An LLM may be prompted to extract a particular target type of information (footnotes, headers, etc.) from the input, and the prompt may include instructions specifying the desired output format (e.g. a JSON, XML, etc.) for use by an end user or a downstream system. Optionally, a user may upload a document to be processed and may provide instructions on the target type of information to be extracted from a document and the output format via a user interface. Alternatively, these instructions may be received as a system prompt. The LLM may then extract information from the document in a page-wise manner, providing discrete outputs including extracted information from each page in the document in the requested format. The outputs for each page that are provided by the LLM model may be assembled into a dictionary object representing the entire document. The dictionary object may be presented to the user in a visual format on a user interface, or the dictionary object may optionally be provided to a downstream system. These dictionary objects may also be stored in a data store of dictionary objects representing other documents. The data store may be queried and accessed by a user or a downstream system for various applications, such as assessing compliance with various rules or regulations based on information reported in the document. Accordingly, the methods described herein enable information from complex documents to be extracted using an AI model and presented to a user or downstream system in a usable, searchable form.

In the following description of the various embodiments, it is to be understood that the singular forms “a,” “an,” and the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

### Data Preprocessing and Extraction

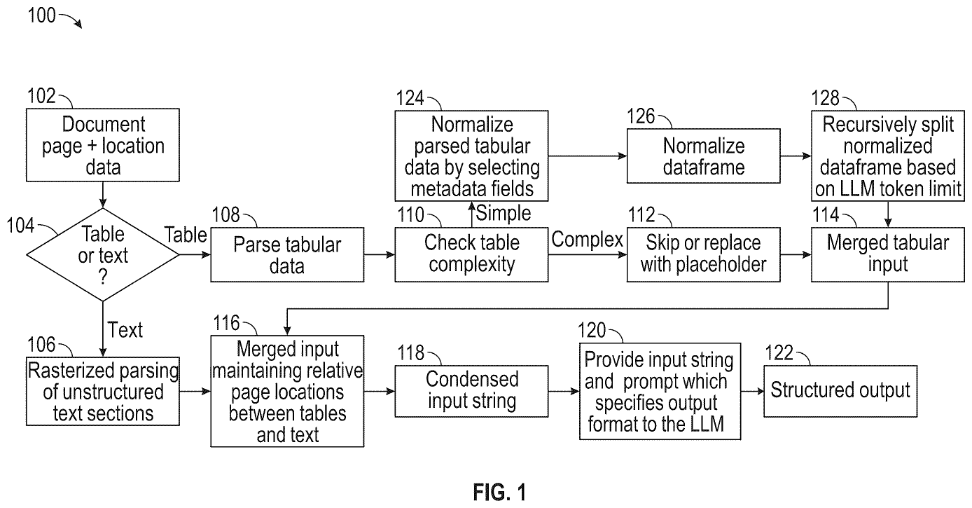

FIG. 1 illustrates an exemplary method 100 of data preprocessing and extraction, according to some examples. Method 100 may be suitable for performing data extraction on complex documents. As used herein, “complex documents” include documents having data represented in multiple different formats (e.g., a combination of unstructured, semi-structured, and/or structured data) as opposed to a standardized format having no structured data, no unstructured data, and/or only a single predetermined kind of structured data. Complex documents may include tax documents such as schedule K-1 forms, schedule K-3 forms, and any other types of documents that include a mix of structured, semi structured and unstructured data. Method 100 may include several steps for preprocessing data in different formats, such as tables and text, to prepare data for extraction by an artificial intelligence (AI) model such as a large language model (LLM).

At step 102, method 100 may include receiving a document file, which may be received as, or later converted into, an Azure Document Intelligence object or any other document file type that is compatible with the OCR engine to be used in the method. In some examples, the received document file may represent a complex document. In some examples, the received document file may be divided into pages, and one or more steps of method 100 may be performed on each page of the document file. Accordingly, method 100 may be repeated for as many times as there are pages in the document file. A document may be received, for example, as a user input (e.g., a document upload) from a user interface and converted by a backend system into the document file to be processed by an OCR engine. In other examples, the document file may be received and/or reformatted at the backend system from a different system (e.g., any other client device or upstream system).

Step 102 may also include receiving location data associated with the document. The location data may include the locations (e.g., page numbers, x and y-bounding coordinates) of one or more types of structured data to be preprocessed from the document. This structured data may include, for example, tables, lists, or other types of structured data. In some examples, the location data may be obtained prior to performing method 100, such as by applying one or more functions and/or optical character recognition (OCR) algorithms to determine the extent of the bounding boxes around the structured data, to determine the corresponding x and y-coordinates of the corners of the bounding boxes, and to determine the page numbers on which the structured data appears. This location data may be stored for each individual document in a data store for use during method 100.

At step 104, the method may include determining whether data to be extracted from the document includes tabular data (a kind of structured data) and/or text data (a kind of unstructured data). Unstructured text data may be distinguished from tabular data using an OCR engine. Metadata including x-and y-coordinates of the corners of the bounding boxes can be used by the OCR engine to distinguish structured data from unstructured text data. For example, data falling outside of the x-and y-coordinates of the bounding boxes can be considered unstructured data since the bounding boxes represent the locations of the structured data. If the metadata indicates that the extracted data is tabular data, method 100 may move to step 108 in which the raw data corresponding to the structure indicated by the location data is parsed. In some examples, the raw data may be parsed using an OCR engine (the same OCR engine used in step 104 or a table-specific OCR engine). Alternatively, the raw data may be parsed using an AI model or other data processing function. Although tables are illustrated as the type of structured data that is preprocessed in the figures, method 100 could be adapted to be performed on other types of structured data without departing from the scope of this disclosure.

At step 110, method 100 may include determining a complexity level of the table. In some examples, a table may be “simple” or “complex.” A table may be considered a “simple” table if the number of rows multiplied by the number of columns equals the total number of cells in the table. In other words, a “simple” table may not include any merged or split cells such that no cells of the table span over multiple rows or multiple columns, or only part of a row or part of a column. In contrast, a “complex” table may have one or more merged or split cells. Therefore, a complex table may not have a regular number of rows across all columns or a regular number of columns across all rows. To determine whether a table is simple or complex, the metadata properties of the table that are extracted by the OCR engine, such as the “header,” the “row span,” and the “column span” metadata properties can be examined. The “header” property may be used to determine if a cell is a header, while the “row span” and the “column span” properties can be used to determine if any cells in a row or column span into a neighboring cell.

If the table is a simple table, then method 100 may move to step 124, which may involve normalizing the data in the table to be read by a downstream generative AI model, such as a large language model (LLM). Step 124 may involve normalizing the parsed tabular data by selecting the metadata fields that are to be included in the merged input while removing extraneous metadata fields. Examples of metadata fields that can be selected for inclusion are x- and y-coordinates, a column span index, a row span index, and other fields related to the location and layout of the table. In some examples, extraneous metadata fields may include a font size, a language field, or any metadata that is irrelevant to the relative location of the table with respect to other information on the document page. The metadata that is to be selected for inclusion in the merged input may be preconfigured as needed by a system administrator and/or a backend user.

Step 126 may include normalizing a dataframe of the parsed tabular data. In this step, the normalized parsed tabular data with the extraneous metadata fields removed at step 124 may be converted into a dataframe, which is a two-dimensional tabular data structure. In some examples, the dataframe may be the pandas dataframe. In some examples, the dataframe may be normalized by ensuring that it has a consistent orientation. For example, a default orientation of the dataframe may be a horizontal orientation, such that any table that is in a vertical orientation may be automatically transposed into a horizontal orientation in step 126. The default orientation may be configurable by a backend user and/or a system administrator, as will be readily understood. The dataframe may also be normalized by scaling or standardizing the values in the rows and/or columns of the dataframe to match a preconfigured set of coordinates (e.g., the expected display coordinates of the structured output after processing by the AI model).

The normalized dataframe may need to be converted into a different input format to be compatible with an AI model (for example, an LLM accepts strings, and not dataframes, as inputs). Accordingly, during step 126, each row or column of the normalized dataframe may be serialized into another object (such as a markdown object) and converted into a string. The lengths of the strings representing each row, or column, may be used to select the AI model that is to be used in method 100. For example, longer strings may require an LLM with a large token limit depending on the number of characters in the string, while a shorter string may allow for a smaller model with a lower token limit to be used in order to preserve computing resources. As the dataframes are serialized and each row or column is converted into a string, the strings representing each row or column of the normalized dataframe can be inputted into the selected LLM one by one until a predetermined token limit of the LLM is exceeded. The number of strings representing the number of rows or columns that came closest to, but did not exceed, the token limit can be used to recursively split the entire normalized dataframe at step 128. The normalized dataframe may be recursively split in order, starting with the first row or column, into groups so that the corresponding strings can be inputted into and processed by the LLM without exceeding the token limit.

Recursively splitting the dataframe in order, as opposed to arbitrarily, allows the structured input to be made more easily digestible by the LLM while preserving the contextual meaning of a string in relation to other strings in the dataframe. For example, if an input string representing five rows of the dataframe exceeds the token limit of the LLM, the normalized dataframe may be recursively split into groups of 4 or fewer rows. The normalized dataframe, as an object, stores the column and row information for each string as metadata, and the table may be recursively split in order from the first to last row and/or column as opposed to being randomly split. Thus, no data or contextual meaning is “lost” by recursively splitting the dataframe, so the input into, and therefore the output out of, the LLM preserves the information on the relative positions and locations of the data in the dataframe.

On the other hand, if a table indicated by the location data is determined to be “complex” (e.g., the number of rows multiplied by the number of columns does not equal the total number of cells), the complex table may be replaced by a placeholder value at the same y-coordinate location in the parsed tabular data. This can make the LLM input more manageable (e.g., further helping to keep the LLM input under the token limit) while still maintaining the relative order of information. At step 114, the strings representing the recursively split rows or columns of the “simple” tables may be combined with the placeholders for the complex tables to create a merged tabular input, which will be further merged with unstructured text data in additional steps. After the input is processed by the AI model and an output is generated, the placeholder value may be replaced by the original complex table, formatted in the requested output format in its original location on the page.

Thus far, method 100 has been described with respect to steps for preprocessing structured (e.g., tabular) data. In some examples, structured data specified in the received location data may be preprocessed first in steps 108-128 and/or 108-114 before unstructured data is preprocessed. Once the structured data is preprocessed, it may be removed from the document page object, leaving only unstructured sections of the document to be parsed at step 106. Since unstructured data may require different preprocessing or may not require preprocessing at all, keeping the unstructured data separate from the structured data during preprocessing may improve the performance of the OCR engine and may improve the accuracy of the parsed output. In other examples, for OCR engines that have the ability to distinguish between structured and unstructured data types, preprocessing of structured data may occur simultaneously with the preprocessing of unstructured data.

At step 106, unstructured and/or semi-structured portions of text data may be parsed from the document page object. The text data may be parsed in a left-to-right and an up-to-down manner. Unstructured text data may be parsed by an OCR engine (e.g., Microsoft Azure Document Intelligence, Amazon Textract, or Google Cloud Vision) based on certain metadata fields corresponding to the text data. For example, text may be parsed into lines based on a “lines” metadata field. Additionally, or alternatively, a “words” metadata field may be used to assemble lines of parsed text more accurately from individual words based on their relative separation and position on the document page as determined from their respective x and y-coordinates. The parsed words may be assembled into lines, converted into a JSON format and sorted in order based on the y-coordinates. The lines can be grouped by proximity, resulting in a dataframe of text information that includes the coordinates of each word on the page and the text content.

The text dataframe can be combined with the merged tabular input from step 114 to create a merged input data structure including text and tabular data elements at step 116. The merged text and tabular input may include the parsed, preprocessed text and tables in a merged list, with the list reflecting the relative order of the text and tabular data on the document page based on the y-coordinates of each data element. The placeholder messages at the complex table locations can be included in the merged list. Additionally, the data elements in the list can be labeled by data type (e.g., text, simple table, or complex table). Therefore, in method 100, unstructured text data and structured tabular data can be parsed from the document page and preprocessed separately, later being recombined into a single input based on their location coordinates from the original document page.

At step 118, the merged list may be converted into a string by joining each element with a newline character. This string, including the text and tabular data elements maintained in their original order, can serve as an input for an AI model that is to be tasked with extracting target information from the document. In some examples, the AI model may be a generative model, such as an LLM as illustrated in FIG. 1.

At step 120, a prompt may be provided to the LLM along with the input string. The prompt may include, for example, instructions on the target type of information that the LLM is to extract from the document (e.g., footnotes, headers, lists, dates, currency types, employer identification numbers, and so on). The instructions may be provided for a particular page, a page range, or for the entire document. In some examples, a user may prompt the LLM to extract a certain type of target type of information from the document through a user interface, as will be described. Additionally, or alternatively, the prompt may be received from an upstream system or an external application. The prompt may also specify the desired format of the LLM, such as JSON, XML, CSV, YAML, or any other desired format.

At step 122, the structured output from the LLM including the requested information may be received. One or more functions may be configured to assess the LLM output for accuracy with the inputted prompt. If the LLM does not provide the output in the format requested in the prompt, the functions may provide the output as a basic response with placeholder values to prevent the process from failing. The LLM output may be modified to include the page number(s) corresponding to the extracted information, and the output may be stored at a storage location (e.g., a local or remote database, system memory, cloud storage, etc.).

As mentioned above, in some examples, method 100 may be repeated until the information requested in the prompt is extracted for all pages of the document. In other words, one iteration of method 100 may be performed for each page in the document. The LLM may be fed the same prompt, but a different merged input, for each new page. The outputs resulting from each iteration of method 100 may optionally be combined into a dictionary that may include, for each extracted piece of information, a dictionary entry that includes the information type (e.g., footnote, header, list, etc.), content, and bounding regions (e.g., page number information, x-and y-coordinates, etc.). The dictionary may be stored, for example, in a data store (e.g., a database, server, etc.) associated with the document or in a data store associated with a broader corpus of information, the broader corpus of information including the processed document. Optionally, information from the dictionary object may be provided to a user as a visual representation in a user interface, where the user may query and/or retrieve information from the dictionary and from dictionaries of other documents as desired. Accordingly, method 100 may allow a user (e.g., a frontend application user) to leverage artificial intelligence to extract target information from complex documents, with the target information accurately reflecting the locations of the data on each page of the document.

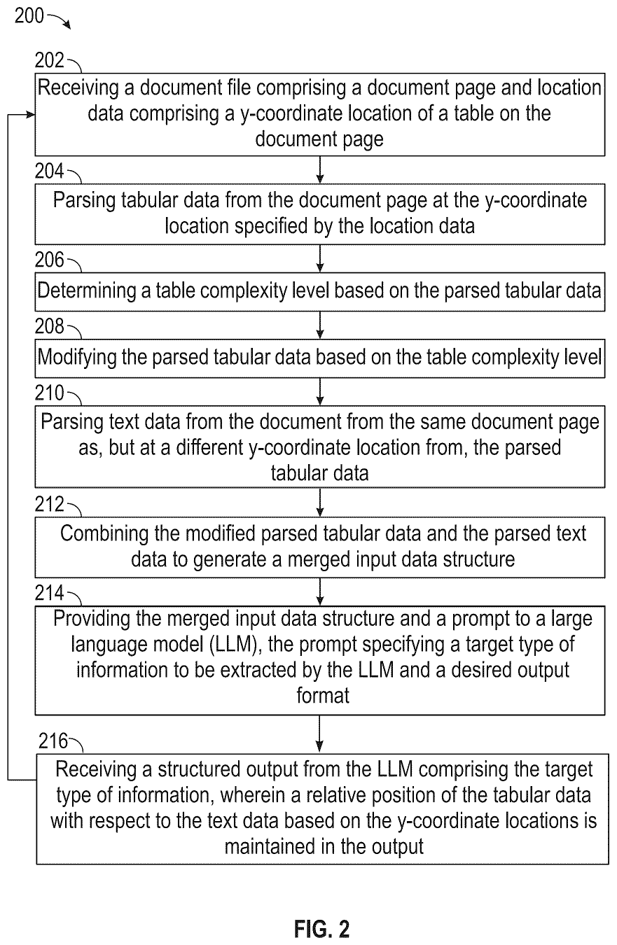

FIG. 2 illustrates an exemplary method 200, which may include some or all of the same steps as method 100 summarized in fewer steps. Step 202 may include receiving a document page and location data comprising a y-coordinate location of a table on the document page. The document and the location data may be received at a user interface, for example. Step 204 may include parsing tabular data from the document page at the y-coordinate location specified by the location data. Step 206 may include determining a table complexity level based on the parsed tabular data. As described with respect to method 100, a table may be considered “complex” if there is not a one-to-one correspondence between the total number of cells in the table and the number of rows multiplied by the number of columns (in other words, if one or more cells are merged or split). A table may be considered “simple” if the number of rows multiplied by the number of columns equals the total number of cells.

Step 208 may include modifying the parsed tabular data based on the table complexity level. Depending on whether the table identified by the location data is a simple table or a complex table, step 208 may encompass any of steps 112-114 (replacing complex tables with placeholder messages) and/or steps 128-132 (normalizing the dataframes of the simple tables) described with respect to method 100. Further, location data may be received for multiple tables on each page. Therefore, steps 204-208 may optionally be repeated for each of the tables on a document page before method 200 moves to the next document page, as will be described.

Step 210 may include parsing text data from the document from the same document page as, but at a different y-coordinate location from, the parsed tabular data. As described with respect to method 100, this step may involve assembling lines of parsed words based on various metadata properties, such as the spacing between words, the average number of words per line, and the spacing between lines on the document page. This step may optionally be performed once all of the tables on the document page have been processed, with the parsed tabular data removed from the document page object before the OCR engine parses the text data.

Step 212 may include combining the modified parsed tabular data and the parsed text data to generate a merged input data structure The merged input data structure may be generated through any combination of steps 116-118 of FIG. 1 (e.g., merging the complex table placeholders and normalized dataframes at step 114, recombining the parsed and processed text and tabular data at step 116, and/or reformatting the merged input into a condensed string). At step 214, the merged input data structure, along with a prompt including instructions for the type of target information to be extracted and a desired output format, may be provided to an AI model such as an LLM. At step 216, a structured output from the LLM comprising the target type of information may be received. A relative position of the tabular data with respect to the text data based on the y-coordinate locations in the original document is maintained in the output. The output(s) received at step 216 for one or more pages of the document can be combined into a dictionary object (e.g., a JSON), and the dictionary object can be provided to a user or downstream system that can use the extracted information in various applications.

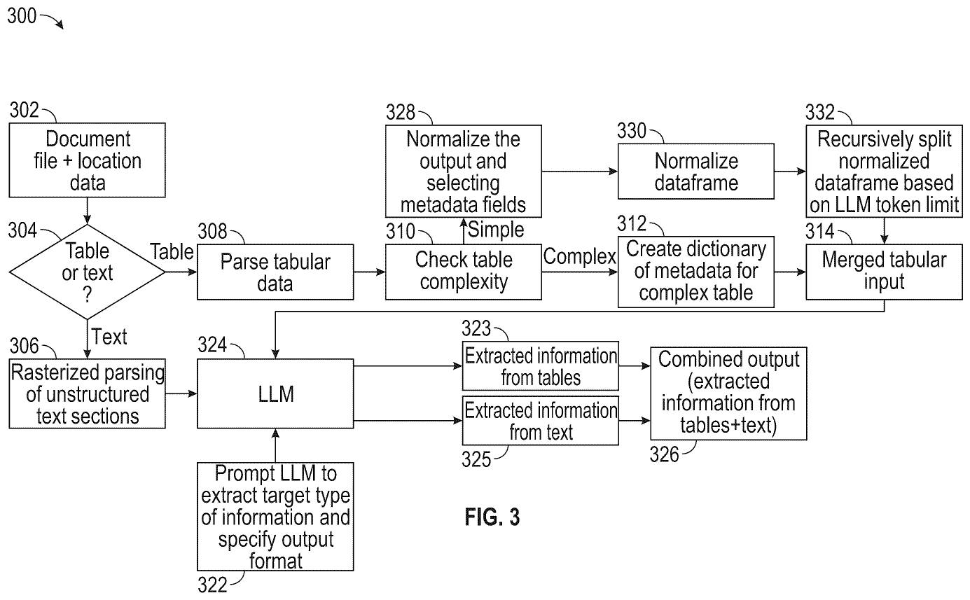

FIG. 3 illustrates an exemplary method 300 of data preprocessing and extraction, according to some examples. Method 300 may include one or more similarities with methods 100 and/or 200 in the performance of several steps, but other steps of method 300 may differ from methods 100 and/or 200. For example, beginning with step 302, a file representing an entire document (e.g., an Azure Document Intelligence object) can be received. Therefore, method 300 may, in some embodiments, only be performed once per document file, as opposed to being repeated for each page in a document. Otherwise, step 302 may include receiving location data indicating the locations (e.g., x- and y-coordinates) of structured data in the document, like step 102 of method 100. Step 304 may involve the same determination with respect to step 104 as to whether the data to be parsed is structured (e.g., a table) or unstructured (e.g., text). The structured and unstructured data can be preprocessed in two different streams in method 300 as in method 100.

Referring to steps 308 and 310, the parsing of the tabular data and the determination as to whether a table is “simple” or “complex” may be performed in the same or a similar manner as in steps 108 and 110 of method 100. The “simple” table processing pathway, including steps 328, 330, and 332, may also be performed in the same or a similar manner as described with respect to steps 124, 126, and 128 of method 100. However, complex tables may be preprocessed in method 300 as described herein. For example, step 312 can involve creating a dictionary of metadata for the complex table, which may assist the LLM in processing the complex data so that it may attempt to extract information from it and generate output data based thereon. The dictionary of metadata can be created, for example, by converting the complex table into markdown format while otherwise keeping the metadata properties of the table the same. This may differ from step 112 of method 100, where the complex tables may be bypassed or replaced with placeholder messages before being inputted into the LLM.

The processed data from the simple and complex tables may be merged together to create a merged list of tabular data at step 314, as with step 114 of method 100. However, method 300 may differ from method 100 in that the processed data from the tables and the processed data from the unstructured text may not be combined into a single input like in step 116 of method 100. For example, while rasterized parsing of the text data identified at step 304 may be performed at step 306 in the same or a similar manner as described with respect to step 106 in method 100, this parsed text data is not combined with the merged list of tabular data into one LLM input in some embodiments. Accordingly, steps 116 and 118 from method 100 may not be performed in method 300 in some embodiments. Instead, the merged list of tabular data from step 312 may be inputted into the LLM in one instance at step 324 without first being combined with any text, while the parsed text data may be inputted into the LLM at a different instance at step 324. At each instance, the LLM may receive a prompt including the target type of information to be extracted and the desired format of the output, indicated at step 322.

Since the LLM may receive two discrete inputs at step 324, two discrete outputs including extracted information from tables 323 and extracted information from text 325 may be provided by the LLM. Then, the text data and tabular data processing streams may be combined at step 326 to create a combined output, such as a dictionary, that includes the extracted information from both the tables and the text. Accordingly, in method 300, the text and tabular data processing streams may be merged in the output, as opposed to method 100 where the text and tabular data processing streams may be merged in the input. Like method 100, the output dictionary in method 300 may be displayed as a visual representation on a user interface.

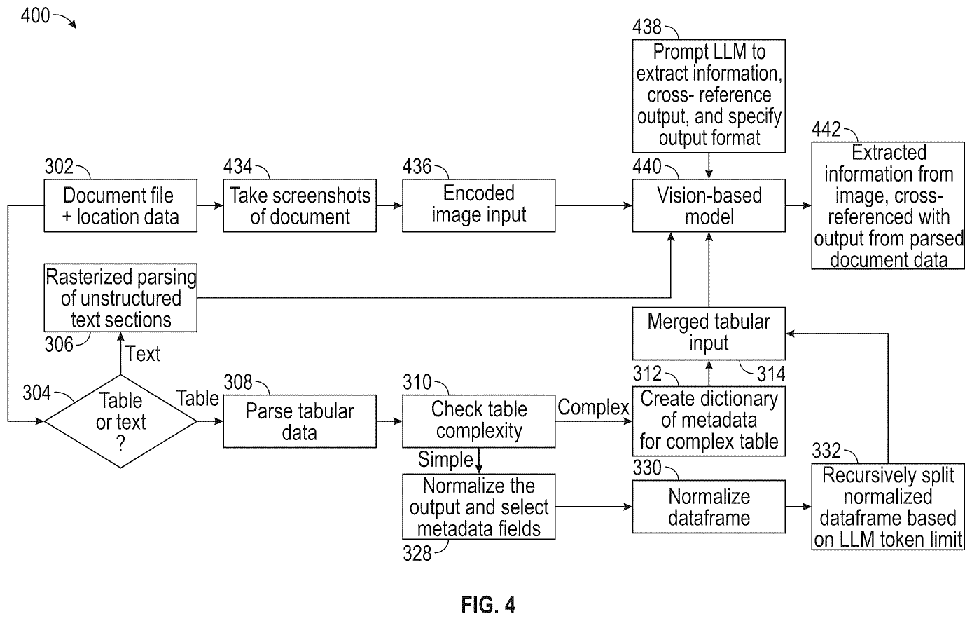

FIG. 4 illustrates an exemplary method 400 of extracting information from complex documents. Method 400 may utilize a vision-based AI model to extract information from complex documents, using techniques from methods 100, 200, and/or 300 to improve the accuracy of the vision-based model's output. Beginning with the image-based portion of method 400, step 434 may involve taking screenshots of a document received at step 302 (e.g., as a user input). Step 436 may involve encoding the screenshots into a format that can be processed by a vision-based model, such as by using a base 64 encoding algorithm to convert the binary image data into a text format that is readable by the vision-based model. The encoded image may be provided to a vision-based model at step 440, along with a prompt, as will be described.

The vision-based model used in method 400 may include, for example, GPT-4o, Claude 3.5, Gemini 1.5, OpenAI o1, or any other multimodal AI model suitable for extracting information from images of complex documents. By using a vision model, less time may be spent on preprocessing the document text and the tabular data, since only the document images need to be processed. Methods 100, 200, and/or 300 may instead be useful for improving the accuracy of the vision model's output in these examples.

For example, FIG. 4 illustrates the same steps that are performed in method 300 for preprocessing text and image data and extracting information from document files. Although steps of method 300 are shown and described with respect to FIG. 4, some or all of the steps of methods 100 and/or 200 may be used in method 400 to improve the accuracy of a vision model's output. Step 302, receiving the document file, and step 304, determining whether the data to be parsed is tabular or text, may be performed in the same manner as described with respect to method 300. The text data and the tabular data may be parsed at steps 306 and 308, respectively, as described with respect to method 300. The determination of the table complexity level at step 310, followed by the performance of step 312 for complex tables and steps 328-332 for simple tables, may also be the same as method 300. Then, the simple and complex tables can be merged at step 314 and provided as an input to the vision model at step 440, while the parsed text data may be provided as a separate input from the merged tabular input as with method 300.

At step 438, the vision model may also receive a prompt, which may include instructions for the target type of information to be extracted from the document and the desired format of the output. At step 438, the prompt may also instruct the vision model to cross-reference the image-derived output with the document file-derived output. Accordingly, the vision model may generate an initial output from the encoded image data that includes the target type of information (e.g., the footnote, header, list, etc.) and a second output that includes the extracted information obtained by following method 300. The vision model may cross-reference the image-derived output with the object-derived output and may correct any inconsistencies in the image-derived output that are identified by comparison with the object-derived output as needed. Then, the verified image-derived output may be formatted as instructed in the prompt, for example, as a dictionary, at step 442.

### Exemplary User Interface and System

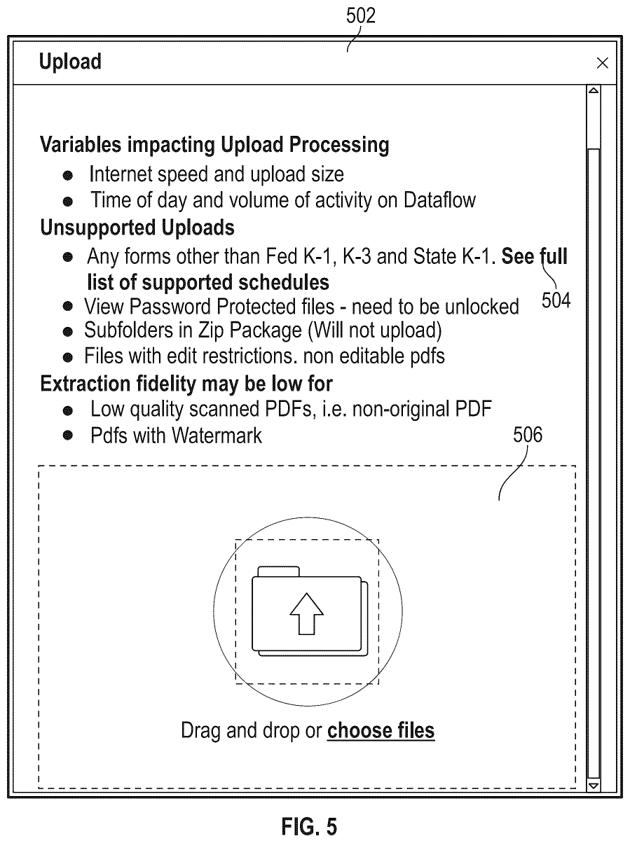

As mentioned above, methods 100, 200, 300, and/or 400 may involve receiving inputs from a user interface and displaying the corresponding outputs on the user interface. FIGS. 5-13B illustrate various features of an exemplary user interface. FIG. 5 illustrates a file upload page 502 of a user interface. The file upload page 502 may include a list of supported and/or unsupported file formats 504. The file upload page may also list the variables that may impact the time needed to process the file and the quality of the resulting output to guide the user in their selection of a file for upload. The user may select a hyperlink for uploading a file in the file selection region 506. Alternatively, a user may drag and drop a file into the file selection region 506. Although not shown in FIG. 5, the file upload page or another part of the user interface may provide a text bar or one or more icons for the user to make selections and/or enter their instructions on the target type of information that they would like to have extracted from the uploaded file.

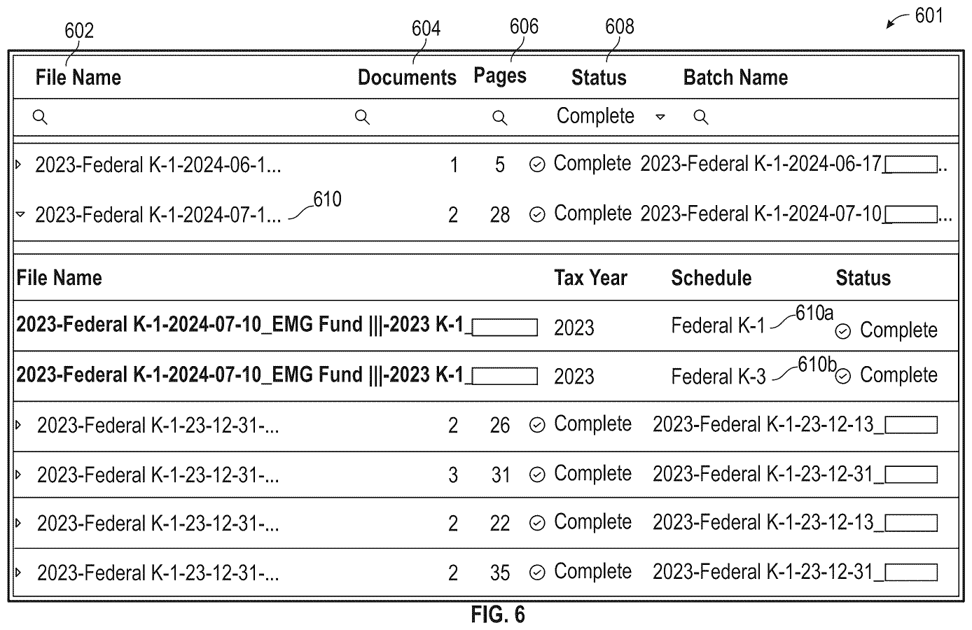

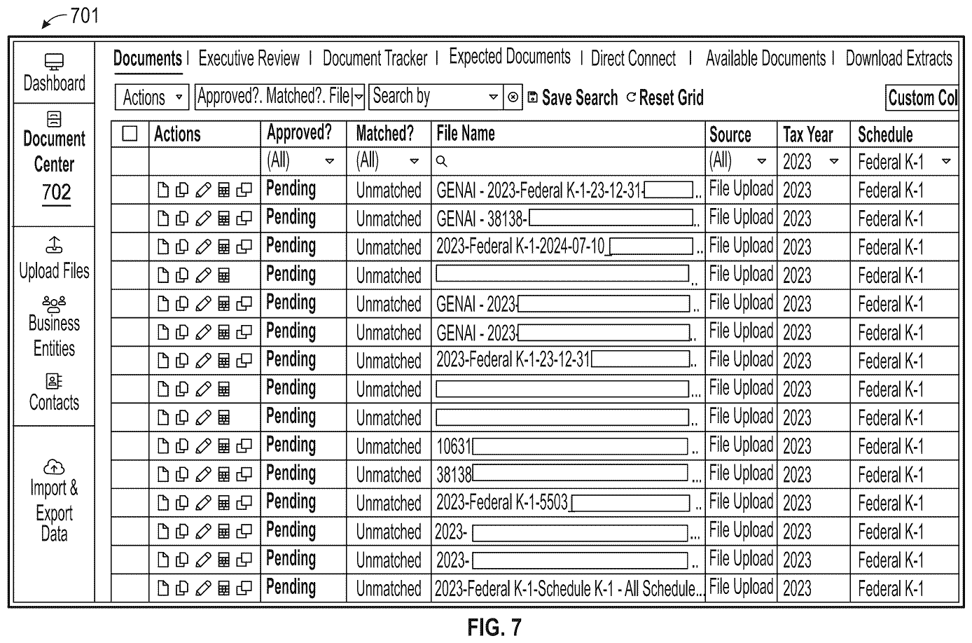

Turning to FIG. 6, after the file upload by the user is provided, a processing status page 601 may be displayed to the user to provide real-time updates on processing status. As shown, the processing status page 601 may display the file name 602. The file may be divided into its constituent documents 604, and the number of constituent documents may be displayed in column 604. The user may optionally select (e.g., click on or tap) a file name in the processing status page 601 to view status information on the constituent documents within a file. For example, in FIG. 6, a user has selected file 610 and has opened a dropdown menu showing the status of two constituent documents, a Schedule K-1 form 610a and a Schedule K-3 form 610b. The total number of pages in the file may be shown at column 606. Once the entire file has been processed and the desired information has been extracted, the processing status column 608 may show a status of “complete.” Processed files may be added to a document repository page 702 of the user interface, which may be accessed by making a selection in a menu 701 displayed in the user interface as shown in FIG. 7. The document repository page 702 may display a dynamic grid that may be sorted, searched through, or filtered by the user in accordance with their preferences.

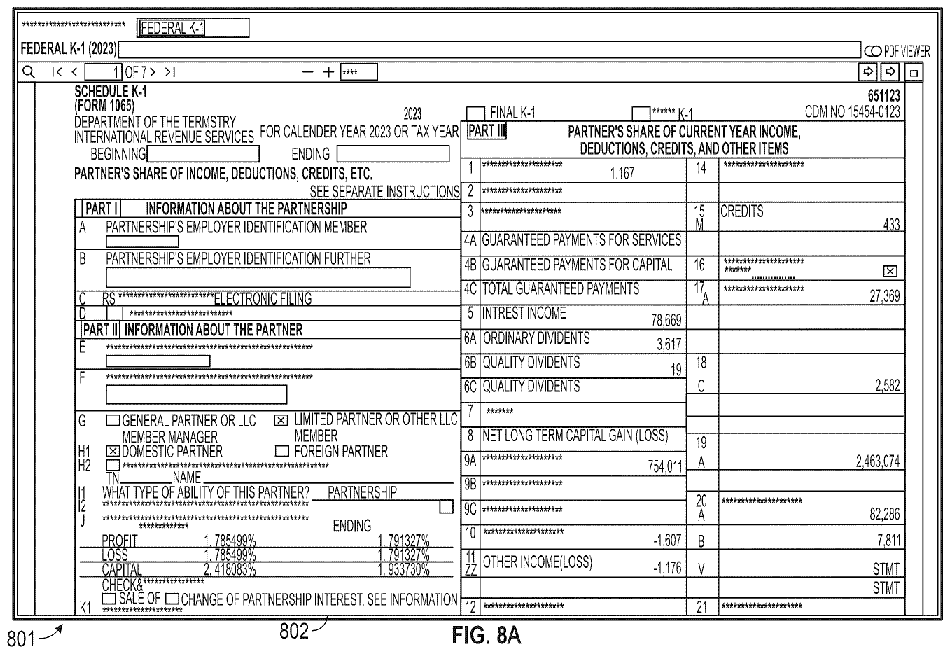

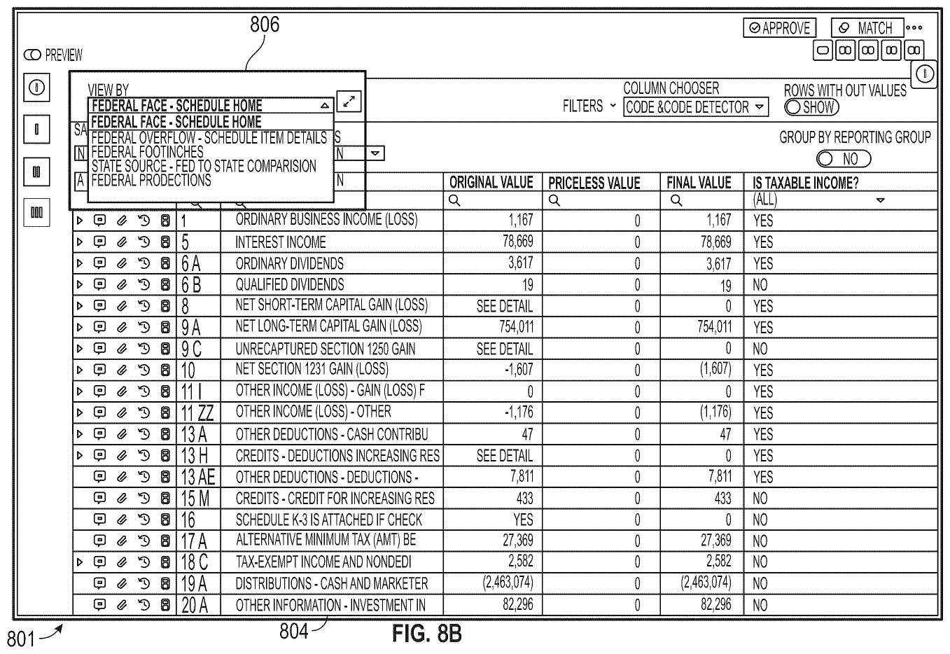

From the document repository page 702, the user may select a file name which may cause the display of a document comparison page 801. One half of the document comparison page 801 is shown in FIG. 8A, which includes a representation of the document from the original file upload 802. The other half of document comparison page 801 is shown in FIG. 8B, which shows the extracted information 804. In some examples, the half of the document comparison page 801 shown in FIG. 8B (the extracted information 804) may be displayed alongside the half of the document comparison page shown in FIG. 8A (the representation of the document from the original file upload 802) to enable a side-by-side comparison. A user may also be able to select different types of extracted information (e.g., schedule items, footnotes, etc.) for viewing using a dropdown menu 806.

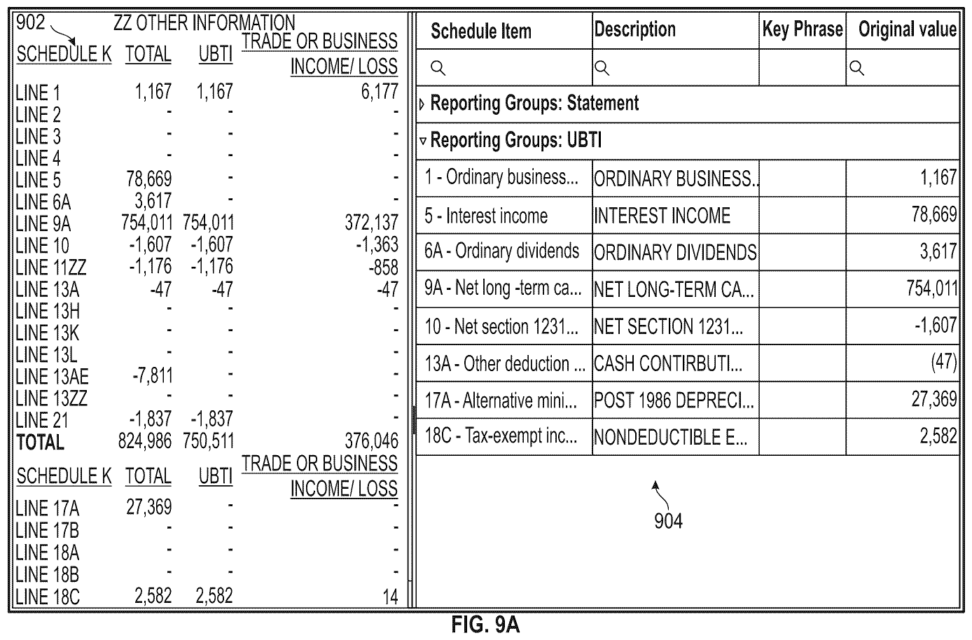

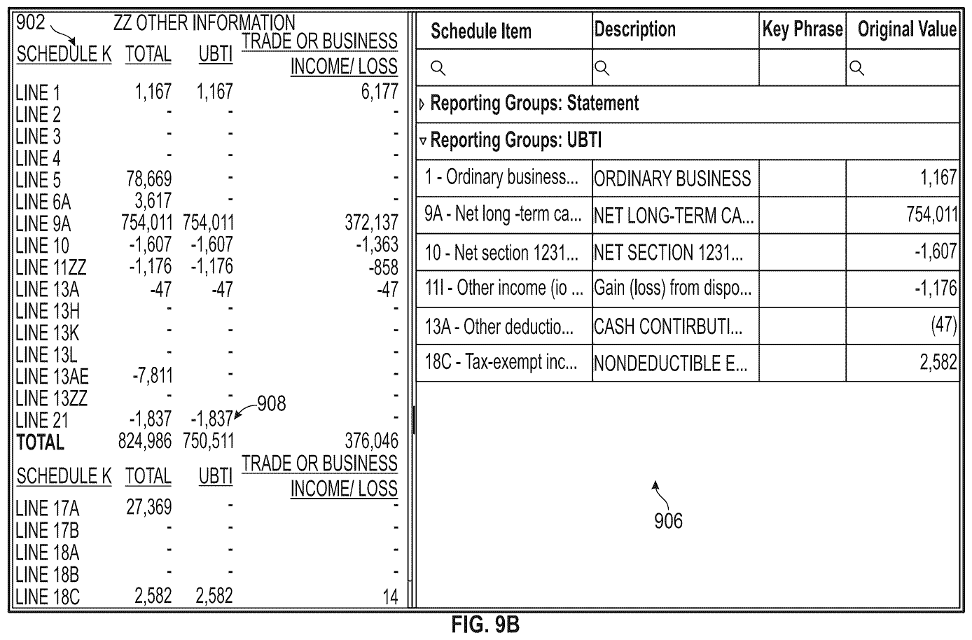

FIGS. 9A-11B illustrate an accuracy comparison of the extracted information outputs when using method 300 described herein compared to the outputs provided by Azure Form Recognizer (hereinafter “AFR,” which has since renamed to Azure Document Intelligence). FIGS. 9A, 10A, and 11A illustrate a comparison between an original document and information extracted using method 300 described herein. FIGS. 9B, 10B, and 11B illustrate a comparison between an original document and information extracted using AFR. Turning to FIG. 9A, which shows the original document 902 and the output 904 from method 300, method 300 led to the accurate identification of lines 5, 6A, and 17A in the Schedule K-1 form where income was reported. Each of the lines in the output 904 are presented in the correct relative order as observed on the page and with the correct income values corresponding to each line. As shown in AFR's output 906 in FIG. 9B, however, AFR failed to extract lines 5, 6A, and 17A and from the original document 902. The corresponding income reported in these lines of the Schedule K-1 is missing from the output 906.

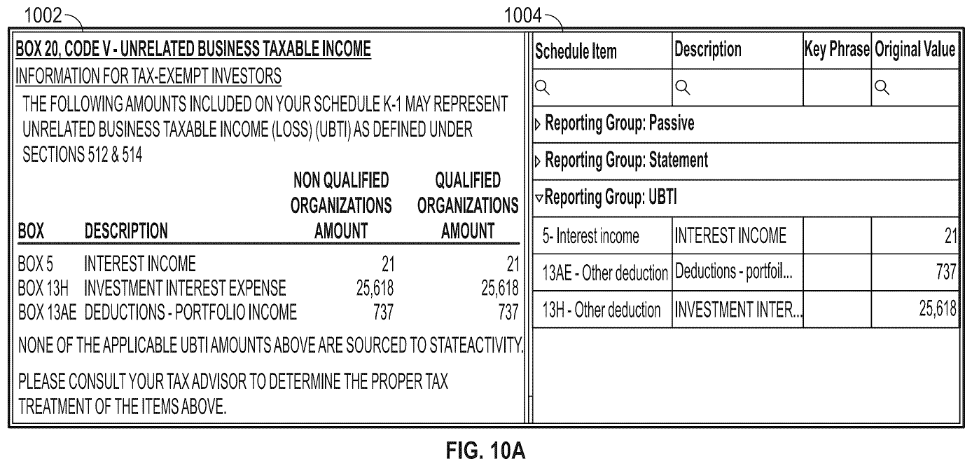

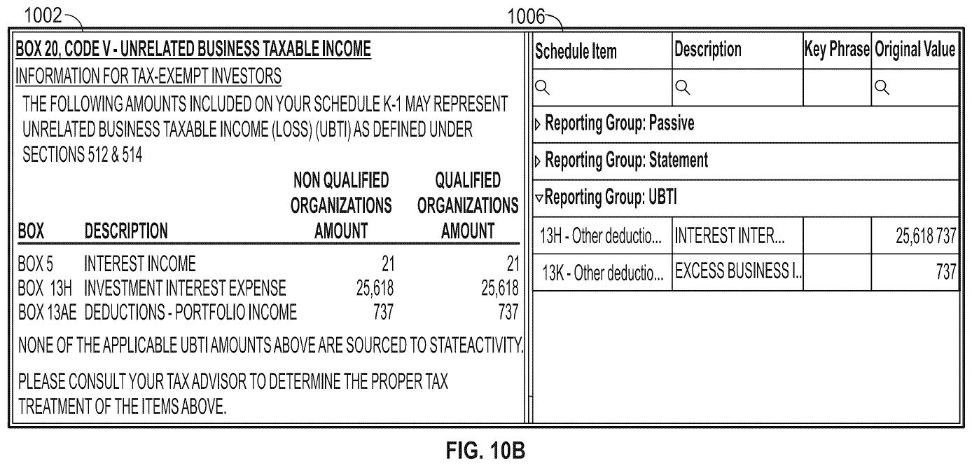

As additionally shown in FIG. 10A, method 300 allowed for the accurate extraction of data from boxes 5, 13AE, and 13H in the original document 1002, with the output from method 300 shown at 1004. As shown in AFR's output 1006 in FIG. 10B, however, AFR failed to extract data from box 5 and mislabeled box 13AE as “13K” in its output 1006. Additionally, AFR incorrectly extracted the amount for box 13H and appended the amount from box 13AE to the end of the box 13H amount.

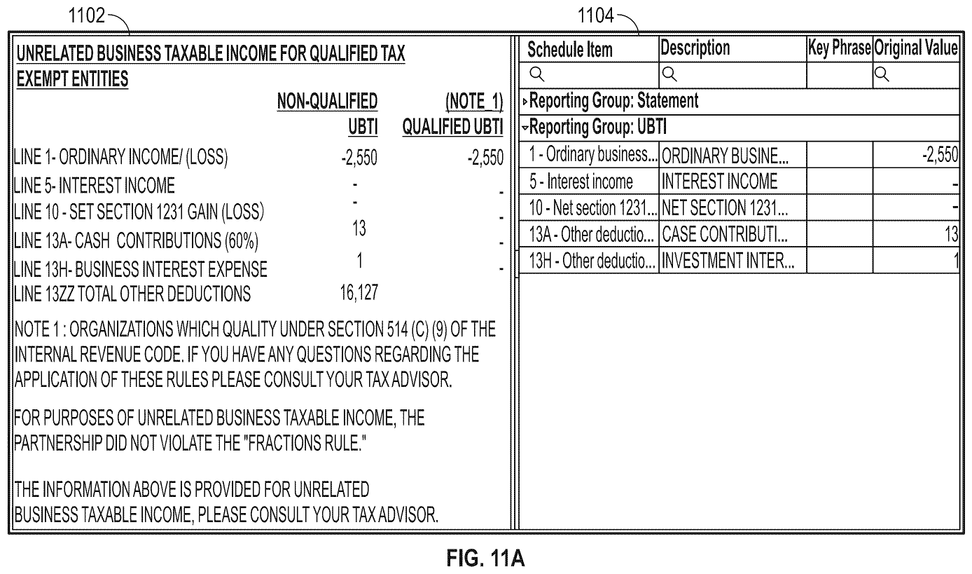

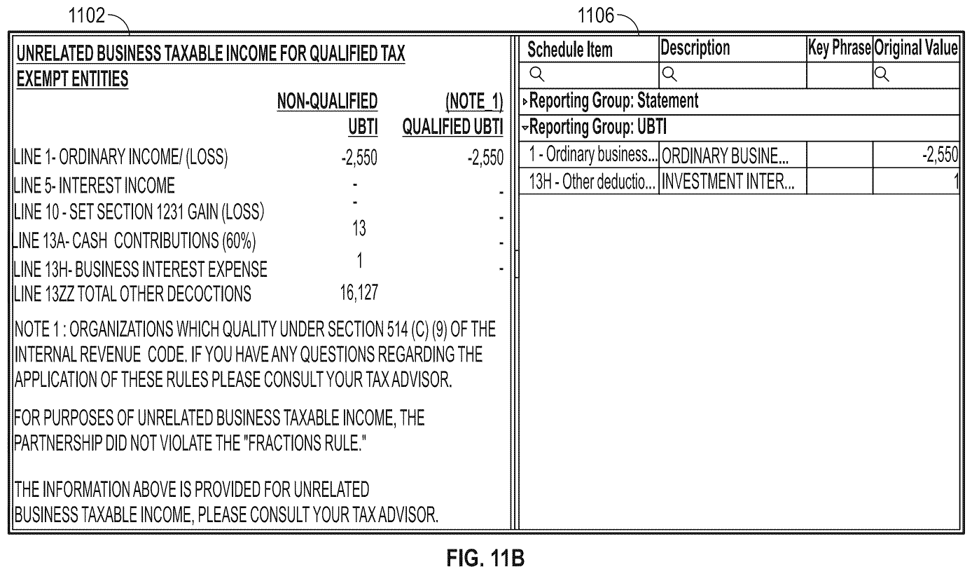

Turning to FIG. 11A, method 300 was found to accurately extract data from document 1102 while maintaining the relative order of information in its output 1104. For example, method 300 was used to extract lines 1, 5, 10, 13A and 13H, with each line including the correct non-qualified UBTI value corresponding to that line of the document in the output 1104. The output of method 300 accounts for lines without a non-qualifying UBTI value, thereby representing the order of lines that were originally present in the document 1102. In contrast, as shown in AFR's output 1106 in FIG. 11B, AFR failed to extract lines 5, 10A, and 13A from the document 1102. Therefore, AFR omitted some of the reported non-qualifying UBTI and provided an incomplete representation of the data from the document 1102. Thus, as can be seen in FIGS. 9A-11B, method 300, representative of the methods herein, can be used to extract and represent information from complex documents more accurately when compared to conventional methods.

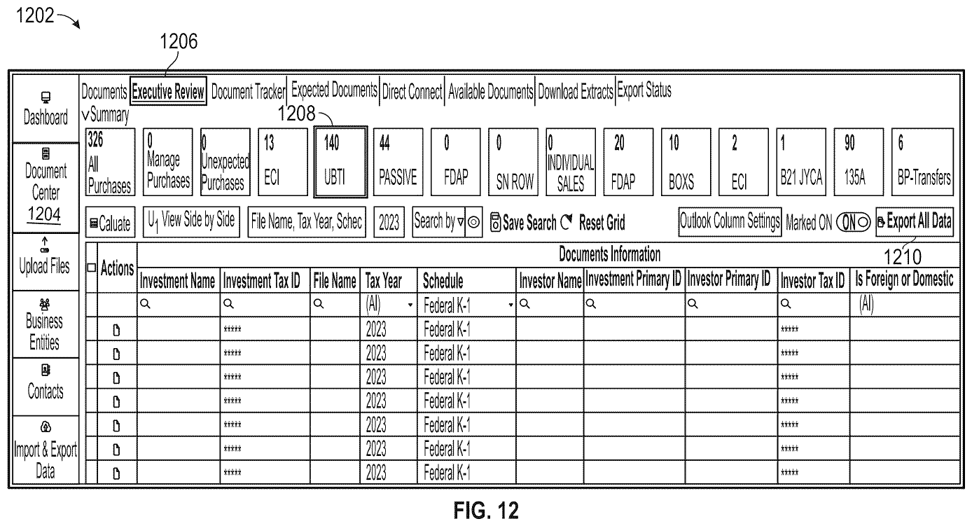

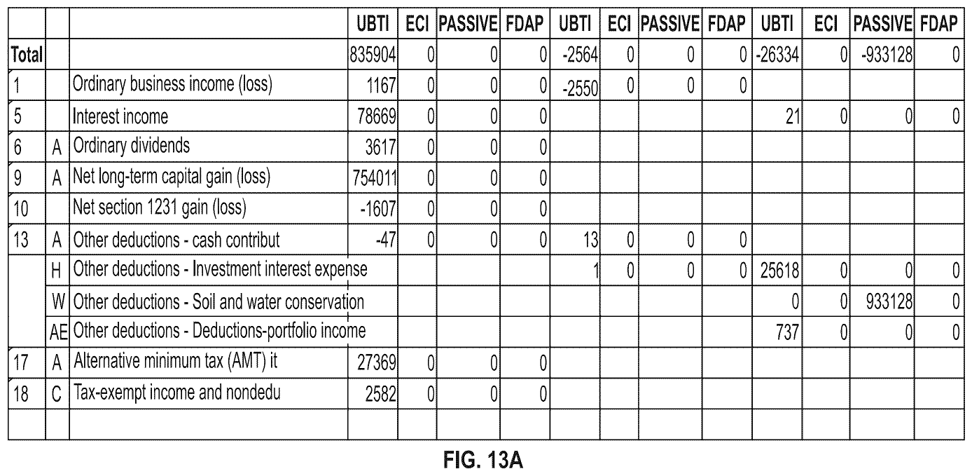

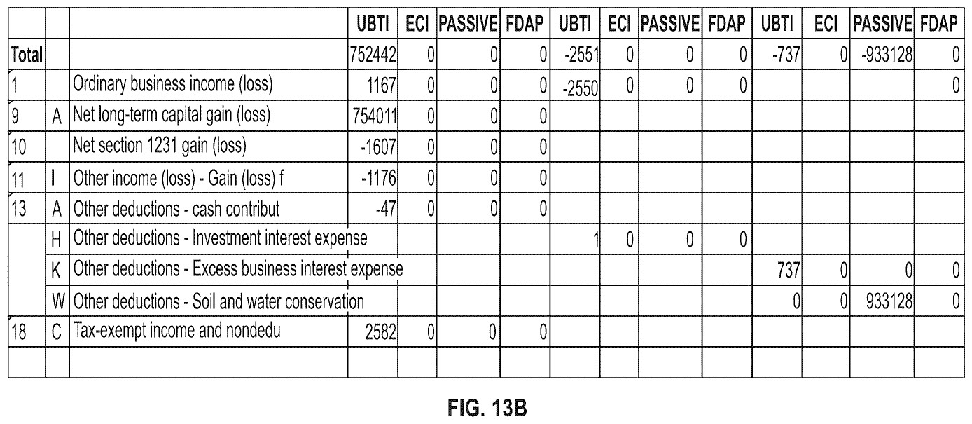

FIG. 12 illustrates an executive review page 1202 of a user interface, which may provide a visual representation of the output from methods 100-400. Executive review page 1202 may be accessed by selecting an executive review tab 1206 from the document repository page 1204. The executive review page 1202 may include numerical representations 1208 of the number of instances of each target type of information that was extracted from the document (e.g., 140 UBTI footnotes, as shown). A user may be able to select a numerical representation 1208 and may be able to drill down to a specific piece of extracted information (e.g., a specific UBTI footnote) that may be of interest to the user. The executive review page 1202 may also include a visual affordance 1210 for exporting the extracted information into an external file, such as an Excel spreadsheet. FIG. 13A provides an example of an Excel spreadsheet exported from the output of method 300, while FIG. 13B provides an example of an Excel spreadsheet exported from AFR's output. Through a direct visual comparison of FIGS. 13A and 13B, method 300 resulted in more lines of extracted data when compared to conventional AFR, suggesting that the methods described herein lead to more comprehensive and complete data extraction.

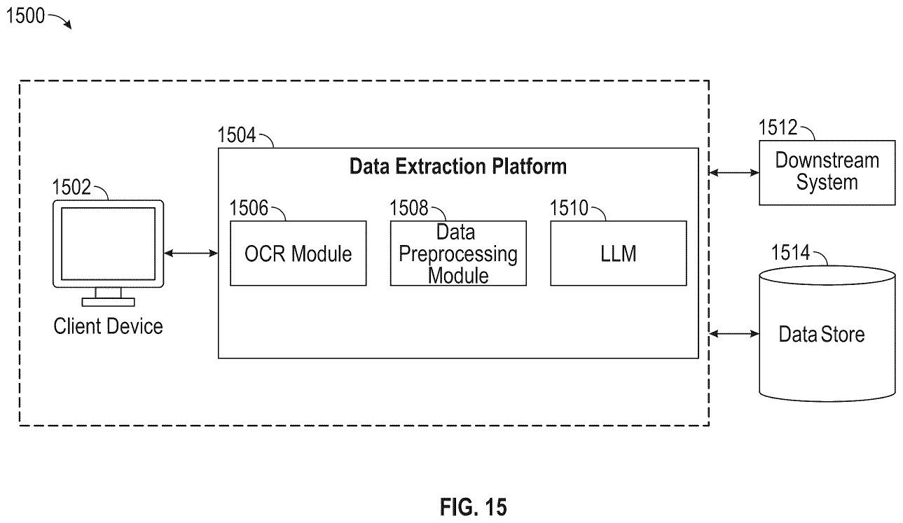

FIG. 15 illustrates a system 1500 for extracting data from documents, according to some examples. System 1500 can be used to perform some or all of the steps of methods 100-400 described herein. System 1500 can include a client device 1502 for receiving user inputs and for displaying various aspects of a user interface, as shown and described with respect to FIGS. 5-13B. Client device 1502 may include one or more processors and may include or be in communication with a display and one or more devices for receiving inputs from a user and/or for displaying outputs. Client device 1502 may be, for example, a desktop or laptop computer, or a mobile device such as a smartphone or a tablet that is connected to a network. Client device 1502 may optionally have a touchscreen for facilitating touch-based interactions with the user interface.

System 1500 may also include a data extraction platform 1504. Data extraction platform 1504 may be configured to receive a document file uploaded by the user at the user interface, or optionally as a request and/or prompt from an upstream system requesting the extraction of information from the document file. Data extraction platform 1504 may include an optical character recognition (OCR) module 1506, a data preprocessing module 1508, and an LLM 1510. The OCR module 1506 may include an OCR engine, such as Azure Document Intelligence, Amazon Textract, or Google Cloud Vision. The OCR engine may be used to extract structured and unstructured data in the manner described with respect to steps 106, 108 of method 100; steps 204, 210 of method 200; and/or steps 306, 308 of method 300 and/or method 400.

Data extraction platform 1504 may include a data preprocessing module 1508. Data preprocessing module 1508 may include one or more programs configured with code to perform the data preprocessing steps of methods 100-400. For example, data preprocessing module 1508 may include calls to one or more functions that are configured for performing, for example, the table complexity check of steps 110, 206, 310; the complex table preprocessing of steps 112-114, 312-314; the simple table preprocessing of steps 128-132, 328-332; the merging of the text and/or tabular inputs and conversion into the corresponding strings at steps 114-116, and/or 314. In some examples, the programming of data extraction platform 1504 may be embodied in code written in any suitable programming language, such as C, C#, C++, Python, Rust, Lua, React JS, Node JS, and/or JavaScript.

Data extraction platform 1504 may include an LLM 1510. The LLM 1510 may be, for example, a multimodal LLM such as GPT model (e.g., GPT-4o, GPT-4 8k, GPT-4 32k), OpenAI o-1, Gemini 1.5, Claude 3, Claude 3.5, Llama 3, or any other AI model suitable for processing complex documents and/or encoded image inputs. Data extraction platform 1504 may be configured to receive and/or generate a prompt for LLM 1510 specifying a target type of information to be extracted from an inputted document file, along with instructions for the desired structure of the LLM's output (e.g., as a JSON or other data structure). Data extraction platform 1504 may also be configured to process the LLM's output, for example, by packaging the data extracted from each page of the document file by the LLM 1510 into a JSON dictionary, or by generating a visualization of the extracted information to be displayed on client device 1502 at the user interface.

Data extraction platform 1504 may be in communication with a downstream system 1512 and/or a data store 1514. The downstream system 1512 may be any system that has either requested the output from data extraction platform 1504 or for which providing the output would be beneficial (for example, an entity who will be using the extracted information from the document file to perform a certain task). The data store 1514 may be any storage location suitable for storing the JSON dictionary output from data extraction platform 1504. For example, data store 1514 may be a database such as MongoDB, Postgre SQL, Azure Cosmos DB, or Amazon DynamoDB. In some examples, data store 1514 may be a local database, a remote database, a server, or a cloud storage solution. The data store 1514 may store multiple dictionary objects corresponding to multiple processed documents, allowing the dictionary objects to be queried for various applications, such as assessing compliance with various rules or regulations based on information reported in the document. In some examples, data store 1514 may also store the locations (e.g., the bounding box coordinates) of the structured data in the inputted document file.

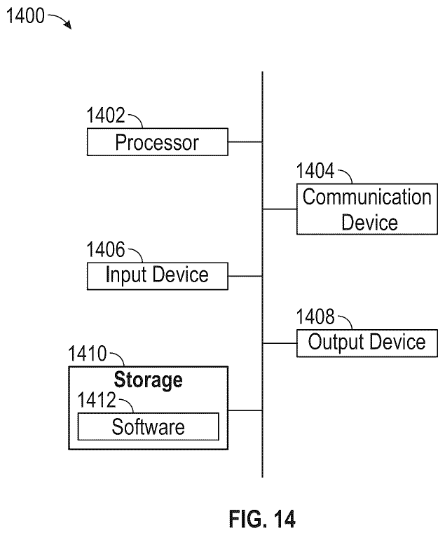

FIG. 14 illustrates a computer 1400, according to some embodiments. One or more parts of system 1500 for implementing methods 100-400 may include one or more parts of computer 1400. For example, client device 1502 may be the same as, or similar to, computer 1400 for receiving inputs and/or displaying outputs to a frontend user. Additionally, computer 1400 can be a host computer connected to a network. As shown in FIG. 14, computer 1400 can be any suitable type of microprocessor-based device, such as a personal computer, workstation, server, or handheld computing device (i.e., a portable electronic device) such as a phone or tablet. The device can include, for example, one or more of processors 1402, input device 1406, output device 1408, storage 1410, and communication device 1404. Input device 1406 and output device 1408 can generally correspond to those described above and can either be connectable to or integrated with the computer 1400.

Input device 1406 can be any suitable device that provides input, such as a touch screen, keyboard or keypad, mouse, or voice-recognition device. Output device 1408 can be any suitable device that provides output, such as a touch screen, haptics device, or speaker.

Storage 1410 can be any suitable device that provides storage, such as an electrical, magnetic, or optical memory, including a RAM, cache, hard drive, or removable storage disk. Communication device 1404 can include any suitable device capable of transmitting and receiving signals over a network, such as a network interface chip or device. The components of the computer can be connected in any suitable manner, such as via a physical bus or wirelessly.

Software 1412, which can be stored in storage 1410 and executed by processor 1402, can include, for example, the programming that embodies the functionality of the present disclosure (e.g., as embodied in the systems and methods as described above).

Software 1412 can also be stored and/or transported within any non-transitory computer-readable storage medium for use by, or in connection with, an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1410, that can contain or store programming for use by, or in connection with, an instruction execution system, apparatus, or device.

Software 1412 can also be propagated within any transport medium for use by, or in connection with, an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by, or in connection with, an instruction execution system, apparatus, or device. The transport-readable medium can include, but is not limited to, an electronic, magnetic, optical, electromagnetic, or infrared wired or wireless propagation medium.

Computer 1400 may be connected to a network, which can be any suitable type of interconnected communication system. The network can implement any suitable communication protocols and can be secured by any suitable security protocols. The network can comprise network links of any suitable arrangement that can implement the transmission and reception of network signals, such as wireless network connections, T1 or T3 lines, cable networks, DSL, or telephone lines.

Computer 1400 can implement any operating system suitable for operating on the network. Software 1412 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A computer-implemented method comprising:
receiving a document file comprising a document page and location data comprising a y-coordinate location of a table on the document page;
parsing tabular data from the document page at the y-coordinate location specified by the location data;
determining a table complexity level based on the parsed tabular data;
modifying the parsed tabular data based on the table complexity level;
parsing text data from the document page, wherein the text data is located at a different y-coordinate location than the tabular data;
combining the modified parsed tabular data and the parsed text data to generate a merged input data structure;
providing the merged input data structure and a prompt to a large language model (LLM), the prompt specifying a target type of information to be extracted by the LLM and a desired output format; and
receiving a structured output from the LLM comprising the target type of information in the desired output format, wherein a relative order of the tabular data with respect to the text data based on the y-coordinate locations in the document page is maintained in the structured output.

2. The computer-implemented method of claim 1, further comprising:
determining that the table complexity level is a complex table; and
in response to determining that the table complexity level is a complex table, modifying the parsed tabular data to replace the table with a placeholder value.

3. The computer-implemented method of claim 1, further comprising:
determining that the table complexity level is a simple table;
in response to determining that the table complexity level is a simple table:
normalizing a dataframe of the parsed tabular data,
recursively splitting the normalized dataframe into a plurality of frames based on a token limit of the LLM, and
modifying the parsed tabular data to include the plurality of frames.

4. The computer-implemented method of claim 1, wherein creating the merged input data structure comprises converting the modified parsed tabular data and the parsed text data into a string, and wherein the computer-implemented method further comprises selecting an LLM to receive the merged input data structure based on a size of the string.

5. The computer-implemented method of claim 1, further comprising:
repeating the steps of the computer-implemented method, from receiving the document file comprising the document page and the location data to receiving the structured output from the LLM, for each page in the document file;
constructing a dictionary object comprising each structured output received from the LLM for each page in the document file; and
storing the dictionary object in a data store.

6. The computer-implemented method of claim 5, further comprising displaying a visual representation of information from the dictionary object at a user interface.

7. The computer-implemented method of claim 6, further comprising:
receiving a user selection of a visual affordance for exporting information from the dictionary object into an external file type; and
in response, exporting the information from the dictionary object into the external file type.

8. The computer-implemented method of claim 6, further comprising:
receiving a user selection of a visual affordance for filtering at least a portion of the information from the dictionary object;
filtering the portion of the information from the dictionary object in response to the user selection; and
displaying a visualization of the filtered portion of the information to a user at the user interface.

9. The computer-implemented method of claim 1, wherein the document file is uploaded by a user at a user interface.

10. A system comprising:
one or more processors, and
memory storing computer program code executable by the one or more processors to cause the system to:
receive a document file comprising a document page and location data comprising a y-coordinate location of a table on the document page;
parse tabular data from the document page at the y-coordinate location specified by the location data;
determine a table complexity level based on the parsed tabular data;
modify the parsed tabular data based on the table complexity level;
parse text data from the document page, wherein the text data is located at a different y-coordinate location than the tabular data;
combine the modified parsed tabular data and the parsed text data to generate a merged input data structure;
provide the merged input data structure and a prompt to a large language model (LLM), the prompt specifying a target type of information to be extracted by the LLM and a desired output format; and
receive a structured output from the LLM comprising the target type of information in the desired output format, wherein a relative order of the tabular data with respect to the text data based on the y-coordinate locations in the document page is maintained in the structured output.

11. The system of claim 10, wherein the system is further caused to:
determine that the table complexity level is a complex table; and
in response to determining that the table complexity level is a complex table, modify the parsed tabular data to replace the table with a placeholder value.

12. The system of claim 10, wherein the system is further caused to:
determine that the table complexity level is a simple table;
in response to determining that the table complexity level is a simple table:
normalize a dataframe of the parsed tabular data,
recursively split the normalized dataframe into a plurality of frames based on a token limit of the LLM, and
modify the parsed tabular data to include the plurality of frames.

13. The system of claim 10, wherein creating the merged input data structure comprises converting the modified parsed tabular data and the parsed text data into a string, and the system is further caused to select an LLM to receive the merged input data structure based on a size of the string.

14. The system of claim 10, wherein the system is further caused to:
repeat the steps of receiving the document file comprising the document page and the location data to receiving the structured output from the LLM, for each page in the document file;
construct a dictionary object comprising each output received from the LLM for each page in the document file; and
store the dictionary object in a data store.

15. The system of claim 14, wherein the system is further caused to display a visual representation of information from the dictionary object at a user interface.

16. The system of claim 15, wherein the system is further caused to:
receive a user selection of a visual affordance for exporting information from the dictionary object into an external file type; and
in response, export the information from the dictionary object into the external file type.

17. The system of claim 15, wherein the system is further caused to:
receive a user selection of a visual affordance for filtering at least a portion of the information from the dictionary object;
filter the portion of the information from the dictionary object in response to the user selection; and
display a visualization of the filtered portion of the information to a user at the user interface.

18. The system of claim 10, wherein the document file is uploaded by a user at a user interface.

19. A non-transitory computer readable storage medium storing one or more programs, the one or more programs comprising instructions, which, when executed by a system comprising one or more processors, cause the system to:
receive a document file comprising a document page and location data comprising a y-coordinate location of a table on the document page;
parse tabular data from the document page at the y-coordinate location specified by the location data;
determine a table complexity level based on the parsed tabular data;
modify the parsed tabular data based on the table complexity level;
parse text data from the document page, wherein the text data is located at a different y-coordinate location than the tabular data;
combine the modified parsed tabular data and the parsed text data to generate a merged input data structure;
provide the merged input data structure and a prompt to a large language model (LLM), the prompt specifying a target type of information to be extracted by the LLM and a desired output format; and
receive a structured output from the LLM comprising the target type of information in the desired output format, wherein a relative order of the tabular data with respect to the text data based on the y-coordinate locations in the document page is maintained in the structured output.

20. A computer-implemented method comprising:
receiving a document file, location data comprising a table location in the document file, and one or more screenshots of one or more pages of the document file;
parsing tabular data from the document file at the table location;
determining a table complexity level based on the tabular data;
upon determining that the table complexity level is a simple table:
normalizing a dataframe of the tabular data, and
recursively splitting the normalized dataframe into a plurality of frames based on a token limit of a large language model (LLM);
encoding the one or more screenshots to create an encoded image input;
receiving an LLM input comprising a string corresponding to each frame of the plurality of frames and the encoded image input, wherein the LLM input does not exceed the token limit; and
receiving an LLM output comprising information extracted from the encoded image cross-referenced with information from the document file.

21. A computer-implemented method comprising:
receiving a document file and location data comprising a table location in the document file;
parsing tabular data from the document file at the table location specified by the location data;
parsing text data at a location in the document file other than the location specified by the location data;
determining a table complexity level based on the tabular data;
upon determining that the table complexity level is a simple table:
normalizing a dataframe of the tabular data, and
recursively splitting the normalized dataframe into a plurality of frames based on a token limit of a large language model (LLM);
receiving a first input at the LLM comprising a string corresponding to each frame of the plurality of frames, wherein the first input does not exceed the token limit;
receiving a first LLM output comprising information extracted from the string;
receiving a second input at the LLM comprising the parsed text data;
receiving a second LLM output comprising information extracted from the parsed text data; and
combining the first LLM output and the second LLM output to create a merged output comprising information extracted from the string and information extracted from the parsed text data.
